(19) United States
(12) Patent Application Publication
(10) Pub. No.: US 2009/0165761 A1
(43) Pub. Date: Jul. 2, 2009

(54) Fuel control system having a cold start strategy

(76) Inventors: Curtis Lyle Fitchpatrick, Williamsfield, IL (US); Brian Gene Wheeler, Metamora, IL (US)

Correspondence Address: CATERPILLAR/FINNEGAN, HENDERSON, L.L.P., 901 New York Avenue, NW, WASHINGTON, DC, 20001-4413, US

(21) Appl. No.: 12/003,614

(22) Filed: Dec. 28, 2007

(51) Int. Cl. F02M 67/14

(52) U.S. Cl. 123/576; 123/478

(57) ABSTRACT

The present disclosure is directed to a method of operating an engine. The method may include determining an injection characteristic based on usage of a primary fuel and determining a need for a secondary fuel. The method may further include determining a first engine characteristic and modifying the injection characteristic based on the need for the secondary fuel and the first engine characteristic. The method may still further include injecting the primary fuel based on the modified injection characteristic and introducing the secondary fuel.

### TECHNICAL FIELD

The present disclosure relates generally to a fuel control system and, more particularly, to a fuel control system having a cold start strategy.

### BACKGROUND

Engines use injectors to introduce fuel into the combustion chambers of the engine. The injectors may be hydraulically or mechanically actuated with mechanical, hydraulic, or electrical control of fuel delivery. Machines that use these engines may be operated in less than ideal atmospheric conditions such as at high altitudes or in cold weather. Under these conditions, particularly cold conditions, an engine may have trouble maintaining the temperature required to sustain combustion. Repeated failed attempts to start an engine in cold conditions may result in excessive wear of the engine.

One way to improve starting and/or operation in cold conditions is to introduce a starting fluid, in addition to normal fuel, into the engine to assist in starting the engine. This starting fluid is a highly flammable liquid that may allow for a higher combustion temperature during cold start conditions and may facilitate operation of an engine that might not otherwise start.

One system for introducing starting fluid into an engine is described in U.S. Pat. No. 5,388,553 (the '553 patent), issued to Burke et al. on Feb. 14, 1995. Specifically, the '533 patent describes a system that introduces an ether mixture into an engine when an engine coolant temperature is below a predetermined temperature and when an engine speed is within a predetermined speed range. Specifically, the system of the '533 patent begins to introduce ether into the engine only when the engine coolant temperature is below 40° F. and when the engine speed is greater than 80 RPM and less than 1800 RPM. The system of the '553 patent stops introducing ether when the engine speed exceeds 1800 RPM regardless of engine coolant temperature. The system of the '553 patent does not introduce ether into the engine if the engine coolant temperature is initially greater than 40° F.

While prior art systems may assist the starting of an engine in cold conditions, inefficiencies may occur throughout engine start up and during engine operation when the engine is being fueled by the starting fluid. Due to the different chemical properties of the starting fluid, the engine injection timing characteristics that may be ideal for the injection of only the normal fuel may not be ideal for use with the starting fluid. Prior art systems may not account for these differences.

The disclosed fuel control system is directed to improving prior art systems.

### SUMMARY

In one aspect, the present disclosure is directed to a method of operating an engine. The method may include determining an injection characteristic based on usage of a primary fuel. The method may also include determining a need for a secondary fuel during starting of the engine and modifying the injection characteristic based on the need for the secondary fuel. The method may still further include injecting the primary fuel based on the modified injection characteristic and introducing the secondary fuel.

In another aspect, the present disclosure is directed to a fuel control system for operating an engine. The fuel control system may include a sensor configured to generate a signal indicative of an engine characteristic. The fuel control system may also include a controller in communication with the sensor and configured to determine an injection characteristic based on usage of a primary fuel. The controller may also be configured to receive the signal indicative of the engine characteristic and determine a need for a secondary fuel. The controller may still further be configured to modify the injection characteristic based on the need for the secondary fuel and the signal, affect the injection of the primary fuel based on the modified injection characteristic, and affect the introduction of the secondary fuel.

### BRIEF DESCRIPTION OF THE DRAWINGS

FIG. 1 is a diagrammatic illustration of an exemplary disclosed power system;

FIG. 2 is a schematic illustration of an exemplary disclosed fuel control system that may be used with the power system of FIG. 1; and

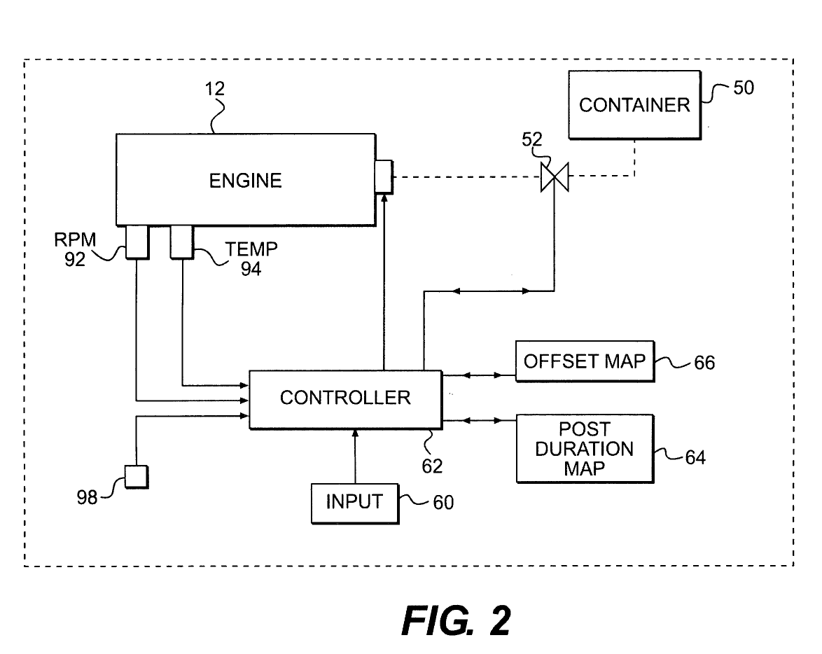

FIG. 3 is a flow diagram illustrating an exemplary disclosed method of operating the fuel control system of FIG. 2.

### DETAILED DESCRIPTION

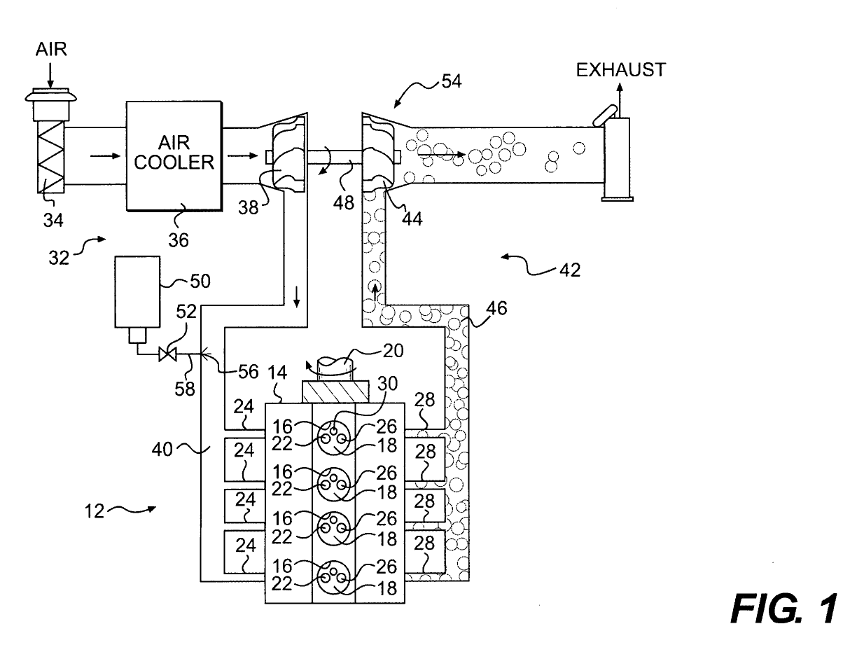

FIG. 1 illustrates an exemplary power system 12. Power system 12 is described herein as a diesel-fueled, internal combustion engine. However, it is contemplated that power system 12 may embody any other type of internal combustion engine, such as, for example, a gasoline or gaseous fuel-powered engine. Power system 12 may include an engine block 14 at least partially defining a plurality of cylinders 16, and a plurality of piston assemblies 18 disposed within cylinders 16. It is contemplated that power system 12 may include any number of cylinders 16 and that cylinders 16 may be disposed in an “in-line” configuration, a “V” configuration, or in any other conventional configuration.

Each piston assembly 18 may be configured to reciprocate between a bottom-dead-center (BDC) position, or lower-most position within cylinder 16, and a top-dead-center (TDC) position, or upper-most position, within cylinder 16. In particular, piston assembly 18 may be pivotally coupled to a crankshaft 20 by way of a connecting rod (not shown). Crankshaft 20 of power system 12 may be rotatably disposed within engine block 14, and each piston assembly 18 coupled to crankshaft 20 such that a sliding motion of each piston assembly 18 within each cylinder 16 results in a rotation of crankshaft 20. Similarly, a rotation of crankshaft 20 may result in a sliding motion of piston assemblies 18. As crankshaft 20 rotates through about 180 degrees, piston assembly 18 may move through one full stroke between BDC and TDC. In one embodiment, power system 12 may be a four stroke (e.g., four cycle) engine, wherein a complete cycle includes an intake stroke (TDC to BDC), a compression stroke (BDC to TDC), a power stroke (TDC to BDC), and an exhaust stroke (BDC to TDC). It is also contemplated that power system 12 may alternatively embody a two stroke (e.g., two cycle) engine, wherein a complete cycle includes a compression/exhaust stroke (BDC to TDC) and a power/exhaust/intake stroke (TDC to BDC).

An intake valve 22 may be associated with each cylinder 16 to selectively restrict fluid flow through a respective intake port 24. Each intake valve 22 may be actuated to move or “lift” to thereby open the respective intake port 24. In a cylinder 16 having a pair of intake ports 24 and a pair of intake valves 22, the pair of intake valves 22 may be actuated by a single valve actuator (not shown) or by a pair of valve actuators (not shown). Of the four piston strokes described above, each intake valve 22 may open during a portion of the intake stroke to allow air or an air and fuel mixture to enter each respective cylinder 16.

An exhaust valve 26 may also be associated with each cylinder 16, and configured to selectively block a respective exhaust port 28. Each exhaust valve 26 may be actuated to move or “lift” to thereby open the respective exhaust port 28. In a cylinder 16 having a pair of exhaust ports 28 and a pair of exhaust valves 26, the pair of exhaust valves 26 may be actuated by a single valve actuator (not shown) or by a pair of valve actuators (not shown). Of the four piston strokes described above, each exhaust valve 26 may open during a portion of the exhaust stroke to allow exhaust to be pushed from each respective cylinder 16 by the motion of piston assemblies 18.

Each of intake and exhaust valves 22, 26 may be operated in any conventional manner to move from the closed or flow blocking position to an open or flow passing position in a cyclical manner. For example, intake and exhaust valves 22, 26 may be lifted by way of a cam (not shown) that is rotatingly driven by crankshaft 20, by way of a hydraulic actuator (not shown), by way of an electronic actuator (not shown), or in any other manner. During normal operation of power system 12, intake and exhaust valves 22, 26 may be lifted in a predefined cycle related to the motion of piston assemblies 18. It is contemplated, however, that a variable valve actuator (not shown) may be associated with any one or more of intake and/or exhaust valves 22, 26 to selectively interrupt the cyclical motion thereof during alternative modes of operation. In particular, one or more of intake and/or exhaust valves 22, 26 may be selectively opened, held open, closed, or held closed to implement a compression braking mode of operation, an exhaust gas recirculation mode of operation, a low-NOx mode of operation, an homogenous combustion compression ignition (HCCI) mode of operation, a starting mode of operation, a cold mode of operation, or any other known mode of operation, if desired.

An air induction system 32 may be associated with power system 12 and include components that condition and introduce compressed air into cylinders 16 by way of intake ports 24 and intake valves 22. For example, air induction system 32 may include an air filter 34, an air cooler 36 located down stream of air filter 34, and a compressor 38 connected to draw inlet air through filter 34 and cooler 36. It is contemplated that air induction system 32 may include different or additional components than described above such as, for example, inlet bypass components, a throttle valve, and other known components. It is further contemplated that compressor 38 may be omitted if a naturally aspirated engine is desired.

Air filter 34 may be configured to remove or trap debris from air flowing into power system 12. For example, air filter 34 may include a full-flow filter, a self-cleaning filter, a centrifuge filter, an electro-static precipitator, or any other type of air filtering device known in the art. It is contemplated that more than one air filter 34 may be included within air induction system 32 and disposed in a series or parallel arrangement, if desired. Air filter 34 may be connected to inlet ports 24 via a fluid passageway 40.

Air cooler 36 may embody an air-to-air heat exchanger or an air-to-liquid heat exchanger disposed within fluid passageway 40 and configured to facilitate the transfer of heat to or from the air directed into cylinders 16. For example, air cooler 36 may include a tube-and-shell type heat exchanger, a plate type heat exchanger, a tube-and-fin type heat exchanger, or any other type of heat exchanger known in the art. By cooling the air directed into cylinders 16, a greater amount of air may be drawn into and combusted by power system 12 during any one combustion cycle. The flow of air directed through air cooler 36 may be regulated by an induction valve (not shown) such that a desired flow rate, pressure, and/or temperature at the inlet of power system 12 may be achieved. Although illustrated as being located upstream of compressor 38, it is contemplated that air cooler 36 may alternatively or additionally be located downstream of compressor 38, if desired. It is also contemplated that air cooler 36 may be omitted if desired.

Compressor 38 may also be disposed within fluid passageway 40 and located downstream of air filter 34 to compress the air flowing into power system 12. Compressor 38 may embody a fixed geometry type compressor, a variable geometry type compressor, or any other type of compressor known in the art. It is contemplated that more than one compressor 38 may be included within air induction system 32 and disposed in parallel or in series relationship, if desired.

An exhaust system 42 may also be associated with power system 12, and include components that condition and direct exhaust from cylinders 16 by way of exhaust ports 28 and exhaust valves 26. For example, exhaust system 42 may include a turbine 44 disposed within a passageway 46 and driven by the exiting exhaust before it is directed to the atmosphere. It is contemplated that exhaust system 42 may include different or additional components than described above such as, for example, exhaust bypass components, an exhaust gas recirculation circuit, an exhaust brake, and other known components.

Turbine 44 may also be disposed within fluid passageway 46 and located to receive exhaust leaving power system 12 via exhaust ports 28. Turbine 44 may be connected to one or more compressors 38 of air induction system 32 by way of a common shaft 48 to form a turbocharger 54. As the hot exhaust gases exiting power system 12 move through passageway 46 to turbine 44 and expand against vanes (not shown) thereof, turbine 44 may rotate and drive the connected compressor 38 to pressurize inlet air. It is contemplated that more than one turbine 44 may be included within exhaust system 42 and disposed in parallel or in series relationship, if desired.

A plurality of fuel injectors 30 may be associated with cylinders 16 to selectively inject pressurized fuel into corresponding combustion chambers (not shown). Fuel injectors 30 may be configured to inject fuel at a timing relative to the angle of crankshaft 20. For example, fuel may be injected as piston 18 nears a top-dead-center position (about 360° of crankshaft rotation) in a compression stroke to allow for compression-ignited-combustion of the injected fuel. Alternatively, fuel may be injected as piston 18 begins the compression stroke (about 180° of crankshaft rotation) heading towards a top-dead-center position for homogenous charge compression ignition operation. Fuel may also be injected as piston 18 is moving from a top-dead-center position towards a bottom-dead-center position during an expansion stroke (approximately 360-540° of crankshaft rotation) for a late post injection to create a reducing atmosphere for after treatment regeneration. The timing, quantity, and/or pressure of each injection may correspond with a particular mode of engine operation; a performance parameter of power system 12 such as engine speed, engine loading, engine temperature, and engine boost pressure; an ambient condition such as temperature; and/or other factors known in the art. In order to accomplish these specific injection events, power system 12 may request an injection of fuel from a controller 62 at a specific start of injection (SOI) pressure or timing and a specific end of injection (EOI) timing or pressure or a specific injection duration. One or more of sensors 92, 94, and 98 may be associated with power system 12 to generate a signal indicative of these parameters

While fuel injectors 30 may inject a primary fuel, for example diesel fuel, directly into the combustion chambers of power system 12, a secondary fuel may be introduced into the combustion chambers by way of induction system 32. The secondary fuel may be introduced instead of or in addition to the primary fuel. In one example, the secondary fuel may include a starting fluid such as diethyl ether, dimethyl ether, or a mixture of diethyl and dimethyl ether, which may be stored in a container 50. The starting fluid may flow or be sprayed into fluid passageway 40 through a line 58. A valve 52 may be disposed in line 58 between container 50 and fluid passageway 40 to selectively restrict the flow of starting fluid into fluid passageway 40. A sensor (not shown) may be able to sense an extent to which valve 52 is open and send a signal indicative thereof to controller 62. Starting fluid that flows into fluid passageway 40 may pass through an atomizer 56. Atomizer 56 may be located to reduce the starting fluid into fine particles as it enters fluid passageway 40 such that it may mix uniformly with the compressed air in fluid passageway 40.

An operator interface device 60 may be associated with power system 12 for manual regulation of the starting fluid. Operator interface device 60 may be configured to receive an input from an operator indicative of a desire to start power system 12. Alternatively it is contemplated that the input could be a computer generated command from an automated system that assists the operator, or a command from an autonomous system that operates in place of the operator. Operator interface device 60 may include a wheel, a knob, a push-pull device, a switch, and other operator interface device known in the art. Operator interface device may be in communication with controller 62.

Controller 62 may be configured to adjust the operation of power system 12 based on the input from operator interface device 60, one or more sensed performance parameters or modes of operation of power system 12, an ambient condition, the sensed position of valve 52, and/or information contained in one or more of electronic maps 64 and 66. Electronic maps 64 and 66 may contain tabulated values indicative of SOI timing modifications, EOI timing modifications, and/or injection duration modifications, and a required movement of valve 52 based on the various inputs. Controller 62 may adjust the SOI timing or pressure, EOI timing or pressure, injection durations of fuel injectors 30, and/or the position of valve 52 based on received signals generated by sensors 92, 94, and 98 and the sensor associated with valve 52.

By way of example, controller 62 may receive a signal from sensor 98 indicating that the ambient temperature may be too low for efficient starting of power system 12, and in response thereto, controller 62 may open valve 52 to utilize a secondary fuel. In another example, controller 62 may receive a signal indicating the rotational speed of power system 12 from sensor 92 being within a starting speed range and the engine coolant temperature from sensor 94 being too low for optimum engine operation. Based on these received signals, controller 62 may then look up a modification, if any, to the SOI timing and pressure, EOI timing and pressure, and/or injection duration. Controller 62 may then modify the injection characteristic accordingly to facilitate starting and/or operation of power system 12 with the use of the secondary fuel.

Controller 62 may embody a single microprocessor or multiple microprocessors that include a means for controlling an operation of power system 12. Numerous commercially available microprocessors can be configured to perform the functions of controller 62. It should be appreciated that controller 204 could readily embody a general microprocessor capable of controlling numerous functions. Controller 62 may include a memory, a secondary storage device, a processor, and any other components for running an application. Various other circuits may be associated with controller 62 such as power supply circuitry, signal conditioning circuitry, solenoid driver circuitry, and other types of circuitry.

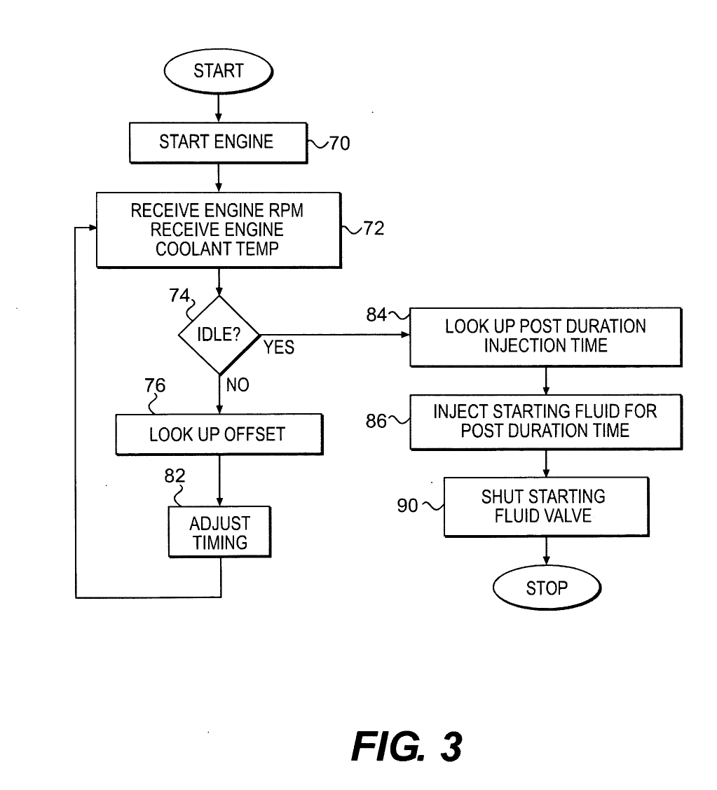

FIG. 3 shows a flow-diagram illustrating a method of controlling fuel injection and starting fluid introduction. FIG. 3 will be discussed in detail in the following section.

### INDUSTRIAL APPLICABILITY

The disclosed fuel control system may be used in connection with any engine where it is desirable to assist starting and/or operation in cold weather. The disclosed fuel control system may adjust fuel injection characteristics based on engine rotational speed and a coolant or ambient temperature when a starting fluid is utilized. By adjusting the injection characteristics, the engine may start more consistently and operate more efficiently. In this manner, the disclosed fuel control system may reduce wear and tear on an engine.

FIG. 3 is a flow diagram illustrating an exemplary disclosed method of operating the fuel control system. An operator may input a command to start power system 12 via operator input device 60. When starting power system 12 in the presence of diesel fuel only, controller 62 may start an injection of diesel fuel into power system 12 via fuel injector 30 at a conventional start of injection (SOI) timing and pressure and a conventional end of injection (EOI) timing and pressure. Additionally, under normal conditions, the flow of the secondary fuel into fluid passageway 40 may be inhibited during starting. However, under cold conditions, fluid passageway 40 may introduce compressed air and the secondary fuel into power system 12. Controller 62 may determine whether to start power system 12 under normal conditions or cold conditions, based on a signal indicative of an ambient temperature received from sensor 98. Controller 62 may open valve 52 if valve 52 is closed and the ambient temperature is below a predetermined threshold.

In block 70, controller 62 may then attempt to start power system 12. Power system 12 may request a conventional SOI timing. In block 72, controller 62 may receive signals indicative of the rotational speed of power system 12 and the engine coolant temperature. In block 76, controller 62 may determine a modification to the conventional SOI timing based on the received signals. The modification may be referred to as an offset, may be a number of degrees to advance or retard the SOI timing, and may be found by referring to offset map 66. In block 82, controller 62 may modify the initial SOI timing or pressure, EOI timing or pressure, and/or injection duration requested by power system 12, and fuel injectors 30 may inject the primary fuel into the combustion chambers based on the modified injection characteristic while the secondary fuel is being introduced into power system 12 via air induction system 32.

In block 74, controller 62 may determine if the rotational speed of power system 12 is below a predetermined idle speed. If power system 12 is below the idle speed, controller 62 may repeat the above mentioned operations at specified intervals or continuously until the sensed rotational speed of power system 12 meets or exceeds the predetermined idle speed. In block 84, once power system 12 meets or exceeds the idle speed, controller 62 may determine a predetermined amount of time to continue introducing the secondary fuel into power system 12 based on the sensed engine coolant temperature. This amount of time may be referred to as post duration time and may be found by referring to post duration map 64. In block 86, the secondary fuel may continue to be introduced into power system 12 for the post duration time. In block 90, after the post duration time has passed, controller 62 may close valve 52. After this point, valve 52 may remain closed and power system 12 may revert to operation under normal conditions (i.e. the flow of secondary fuel is inhibited, and the continued injection of diesel fuel into power system 12 through fuel injector 30.)

For example, the predetermined threshold for power system 12 to begin a cold mode of operation may be an ambient temperature below 32° F. and the predetermined idle speed may be greater than 700 RPM. If the ambient temperature is −10° F., controller 62 may open valve 52 to allow the secondary fuel to be introduced into power system 12. Furthermore, the speed of power system 12 may initially be 0 RPM and the engine coolant temperature may be 0° F. Power system 12 may request a conventional SOI timing of 20° before top-dead-center. Controller 62 may then reference map 64 and determine that the SOI timing should be modified, specifically that the SOI timing may be retarded by 10° such that the final SOI timing may be 10° before top-dead-center. The speed of power system 12 may next be 500 RPM and the engine coolant temperature may be 0° F. Power system 12 may request a SOI timing of 20° before top-dead-center. Controller 62 may reference map 64 and determine that the SOI timing should be retarded by 7° such that the modified SOI timing may be 13° before top-dead-center. The speed of the power system may next be greater than 700 RPM and the engine coolant temperature may be 0° F. Controller 62 may determine that the speed of power system 12 is greater than the predetermined idle speed. Controller 62 may then reference map 62 and may determine a post duration time of 5 seconds. After 5 seconds, controller 62 may then close valve 52.

Several advantages of the disclosed fuel control system may be realized. In particular the disclosed fuel control system may be used in conjunction with any engine where it is desirable to assist starting and/or operation in cold weather. The disclosed fuel control system may adjust injection characteristics based on engine rotational speed and coolant temperature when a secondary fuel is utilized. Furthermore, the disclosed fuel control system may adjust the injection characteristics at multiple times at intervals or continuously. By adjusting the injection characteristics, an engine may start more consistently and operate more efficiently. In this manner, the disclosed control system may reduce wear on an engine.

It will be apparent to those skilled in the art that various modifications and variations can be made to the fuel control system of the present disclosure. Other embodiments of the fuel control system will be apparent to those skilled in the art from consideration of the specification and practice of the injection system disclosed herein. By way of example, it would be apparent to those skilled in the art that variations of starting fluid or fluids not containing ether mixtures may be used as a starting aid. It is intended that the specification and examples be considered as exemplary only, with a true scope being indicated by the following claims and their equivalents.

What is claimed is:

1. A method of operating an engine, the method comprising:
determining an injection characteristic based on usage of a primary fuel;
determining a need for a starting fluid during starting of the engine;
modifying the injection characteristic based on the need for the starting fluid;
injecting the primary fuel based on the modified injection characteristic;
introducing the starting fluid; and
stopping the introduction of the starting fluid after a predetermined amount of time after an engine speed exceeds a predetermined threshold.

2. The method of claim 1, wherein the need for the starting fluid is based on ambient temperature.

3. The method of claim 1, further including determining an engine characteristic.

4. The method of claim 3, wherein the engine characteristic is one of an engine speed and a coolant temperature and wherein the modified injection characteristic is based on the engine characteristic.

5. The method of claim 1, further including opening a valve to introduce the starting fluid in response to the need for the starting fluid.

6. The method of claim 1, wherein the primary fuel is a diesel fuel and the starting fluid includes ether.

7. The method of claim 3, further including:
determining the engine characteristic at multiple intervals; and
modifying the injection characteristic at each interval.

8. (canceled)

9. The method of claim 1, wherein the predetermined amount of time is based on an engine coolant temperature.

10. A fuel control system for operating an engine, comprising:
a sensor configured to generate a signal indicative of an engine characteristic; and
a controller in communication with the sensor and configured to:
determine an injection characteristic based on usage of a primary fuel;
receive the signal indicative of the engine characteristic;
determine a need for a starting fluid;
modify the injection characteristic based on the need for the starting fluid and the signal;
affect the injection of the primary fuel based on the modified injection characteristic;
affect the introduction of the starting fluid; and
stop the introduction of the starting fuel after a predetermined amount of time after the engine characteristic exceeds a predetermined threshold.

11. The system of claim 10, wherein the engine characteristic is a rotational speed of the engine.

12. The system of claim 10, wherein the engine characteristic is an engine coolant temperature.

13. The system of claim 10, wherein the need for the starting fuel is based on an ambient temperature.

14. The system of claim 10, wherein the primary fuel is a diesel fuel and the starting fluid includes ether.

15. The system of claim 10, wherein the controller is further configured to:
determine the engine characteristic at multiple intervals; and
modify the injection characteristic at each interval.

16. (canceled)

17. The system of claim 10, wherein the predetermined amount of time is based on an engine coolant temperature.

18. An internal combustion engine, comprising:
an engine block having at least one combustion chamber;
a fuel injector configured to inject a pressurized primary fuel into the combustion chamber;
a speed sensor configured to generate a signal indicative of an engine speed; and
a controller in communication with the speed sensor and the fuel injector, the controller being configured to:
determine a need for a secondary fuel;
modify an injection characteristic of the fuel injector based on the need for the secondary fuel and the engine speed;
introduce the secondary fuel; and
stop the introduction of the secondary fuel after a predetermined amount of time after the engine speed exceeds a predetermined threshold.

19. The engine of claim 18, wherein the controller is further configured to:
determine the engine speed at multiple intervals; and
modify the injection characteristic at each interval.

20. The engine of claim 18, wherein the predetermined amount of time is based on an engine temperature.
